(19) United States
(12) Patent Application Publication
(10) Pub. No.: US 2008/0227876 A1
(43) Pub. Date: Sep. 18, 2008

(54) Method for the modification of rubber and thermoplastic waste by means of grafting during a grinding process, and use of the rubber and thermoplastic waste modified in this way

(76) Inventors: Klaus Thiele, Hildesheim (DE); Cristel Rom, Halle/Saale (DE); Ute Winkler, Halle/Saale (DE)

Correspondence Address: COLLARD & ROE, P.C., 1077 NORTHERN BOULEVARD, ROSLYN, NY, 11576, US

(21) Appl. No.: 12/075,337

(22) Filed: Mar. 11, 2008

(30) Foreign Application Priority Data
Mar. 12, 2007 (DE) 10 2007 011 825.4

(51) Int. Cl. C08J 11/04

(52) U.S. Cl. 521/42; 521/42.5; 521/43.5

(57) ABSTRACT

A method produces polar-modified rubber and olefin thermoplastic waste by grafting during a grinding process, for treatment, usable as compatibility agents in various plastic blends and composites, without the disadvantages of known functionalized recycled plastics, particularly the mechanical characteristics that are insufficient for their use. The waste is simultaneously ground and graft-modified in a temperature range between 40° C. and 140° C., in one method step. Scrap parts of vulcanized elastomer or olefin thermoplastic are comminuted to a particle size diameter of approximately 4 and 8 mm. The waste should be sorted by type, if possible. The shredded material is mixed with at least one organic peroxide and an α,β-ethylene compound possessing at least one unsaturated polar group. The mixture is simultaneously ground and grafted at a specified dwell time and temperature range to a particle size diameter <1 mm. Residual components and byproducts are removed via nitrogen flushing.

### CROSS REFERENCE TO RELATED APPLICATIONS

Applicants claim priority under 35 U.S.C. §119 of German Application No. 10 2007 011 825.4 filed Mar. 12, 2007.

### BACKGROUND OF THE INVENTION

1. Field of the Invention

The present invention relates to a method for the production of polar-modified rubber and olefin thermoplastic waste by means of grafting during a grinding process, for treatment, and to the use of rubber and thermoplastic waste modified in this way

2. The Prior Art

EP 1362681 A1 discloses a grinding process, according to which scrap parts of vulcanized elastomers are processed to produce fine-particle rubber meals.

The grinding system described in the EP publication consists essentially of a rotor and a stator that move with regard to one another. Rotor and stator are profiled and provided with a gap of approximately 1 to 2 mm. The shredded rubber scrap parts are forced up to this gap in the grinding system. They are then rubbed up on the profiling, resulting in rubber meals having particle sizes <1 mm, which can be used again as a new material. During this process, temperatures of up to 140° C. occur.

Furthermore, it is known to modify elastomers having different degrees of crosslinking, including (fully vulcanized) rubber, and thermoplastic plastics, by means of grafting of polar monomers, particularly monomers that contain carboxyl or anhydride, amine and hydroxyl groups (U.S. Pat. No. 3,862,265, U.S. Pat. No. 4,443,584, U.S. Pat. No. 4,652,326, EP 0268486).

Graft modification, particularly of thermoplastic olefin plastics, according to various methods, is frequently used. Graft polymerization in homogeneous organic solutions (DE 2023154, DE 3910062, EP 0485983) or in aqueous suspensions (EP 0001313, DE 2326589) are not economically justifiable due to the use and recovery of larger amounts of solvents and suspension agents, respectively. In addition to these processes, melt grafting technologies are commercially utilized, in most cases (DE 2242324, DE 2326589, U.S. Pat. No. 3,177,269, U.S. Pat. No. 3,177,270).

According to GB 934,038, it is taught that modification of rubber waste can take place by means of grafting and simultaneous grinding. It can be assumed that the grafting is carried out at elevated temperature, for purposes of acceleration and activation.

Supplementally, it should also be noted that in GB 697,562, an analogous modification method to the one in GB 934,038 is mentioned, whereby here, a statement concerning temperature is made. The method is carried out at temperatures up to 100° C., but here, the work is not carried out with rubber and thermoplastic waste.

Furthermore, grafting of polar monomers onto thermoplastic materials, for example, such as polypropylene and other olefin homopolymers and copolymers, in solid, mostly powder, grain, or granulate phase, is known (DD 275 159 A3, DE 4342605 A1, EP 0519341 B1). For the functionalization of special elastomers, grafting in solid elastomer phase is also known (DD 136971, EP 0642538 B1).

While the main disadvantage of graft polymerization methods in the thermoplastic or elastomer melt lies in polymer decomposition and the great reduction in the polymer characteristic value level connected with this decomposition, the known solid-phase graft technologies are not known for recycled rubber and thermoplastic waste products, because only low degrees of grafting are achieved.

### SUMMARY OF THE INVENTION

It is an object of the present invention to provide a method for the production of polar-modified rubber and olefin thermoplastic waste that can be used as compatibility agents in various plastic blends and composites, without the disadvantages of known functionalized recycled plastics that were described, particularly the mechanical characteristics that are insufficient for their use.

These and other objects are achieved by a method according to the invention. Preferred embodiments of the invention are discussed below.

The method according to the invention has the following steps:
A) Comminution (shredding) of the scrap parts consisting of vulcanized elastomer (rubber) or olefin thermoplastic in a comminution system (shredder), to a particle size diameter of approximately 4 and 8 mm, whereby the waste should be present sorted by type, if at all possible,
B) Mixing of the shredded elastomer or thermoplastic material with at least one organic peroxide and an α,β-ethylene compound possessing at least one unsaturated polar group (polar monomer) in a mixing system,
C) Simultaneous grinding and grafting of the mixture produced in step B), in a grinding system of a known type, at a dwell time between 30 seconds and 10 minutes, within a temperature range between 40° C. and 140° C., to a particle size diameter <1 mm, and
D) Removal of residual monomer components and volatile reaction byproducts from the ground reaction product, by means of nitrogen flushing.

During this grinding process, for example in a grinding system as described in EP 1362681 A1, the peroxide breaks down into radicals at the temperatures indicated in step C), and initiates grafting of the polar monomer onto the surface of the elastomer or thermoplastic olefin polymer. The temperatures of step C) are adjustable, in targeted or variable manner, by means of a cooling unit.

The products obtained at a high grafting yield by means of the method according to the invention have a high degree of grafting and can be used as compatibility agents and/or adhesion agents in various polymer and elastomer blends, as well as thermoplastic polymer composites.

Furthermore, the surface-modified rubber meals, in particular, are preferably also suitable as absorbents.

Grafting takes place directly in the grinding system, whereby the grafting parameters, particularly the grafting yield and degree of grafting, as well as also graft branch length and density, can be adjusted by way of the specific type and concentration of the monomer or monomer mixture, as well as the peroxide or peroxide mixture used, and the temperature.

While longer graft branches are obtained on the rubber meals during rubber grinding and grafting by means of lower temperatures, for example, smaller graft branches occur in greater numbers at high temperatures and a constant monomer concentration.

The crosslinked elastomers may include recycled rubber on an elastomer basis of ethylene-propylene-diene terpolymers (EPDM), natural rubber (NR), styrene-butadiene rubber (SBR), butadiene rubber (BR), acryl nitrile-butadiene rubber (NBR), polyisoprene (IR), butyl rubber (IIR), chloroprene rubber (CR), epichlorhydrine copolymer rubber (ECO), ethylene/acrylate copolymer rubber (AEM), acrylate rubber (ACM), and silicone rubber. The olefin thermoplastics may include recycled thermoplastics on the basis of polypropylenes (PP), preferably propylene homopolymers (HPP), statistical and hetero-phase propylene copolymers (RCP, HCP) and of polyethylenes (PE), preferably high density polyethylene (HDPE), low density polyethylene (LDPE), and linear low density polyethylene (LLDPE), and ethylene copolymers, preferably ethylene/vinyl acetate (EVA), ethylene/(meth)acrylate copolymers (EMA). These cross-linked elastomers and olefin thermoplastics preferably can be used in the method according to the invention, which involves shredding to produce the particle size suitable for grinding, subsequent mixing with the monomer(s) and the peroxide initiator, and the combined grinding and grafting process.

The polar monomers to be grafted preferably include acrylic acid, maleic acid anhydride, acryl amide, vinyl acetate, and vinyl acetate/styrene mixtures.

Taking the concrete half-life values into consideration, the organic peroxides dibenzoyl peroxide, dilauroyl peroxide, and dicumyl peroxide are preferably used as radical-forming initiators.

### DETAILED DESCRIPTION OF PREFERRED EMBODIMENTS

The method according to the invention will be explained in greater detail below, using the following examples.
Reference is made to Tables 1 and 2:
Table 1: Grinding and grafting of recycled rubber
Table 2: Grinding and grafting of recycled thermoplastic

### EXAMPLE 1

100 mass parts of an EPDM shredded to an average particle diameter of approximately 4 to 8 mm are mixed, in a mixer, with 5 mass parts maleic acid anhydride and 2 mass parts dibenzoyl peroxide, at room temperature, under nitrogen atmosphere. Subsequently, this mixture is metered into a grinding system as described in EP 1362681 A1, and ground and, at the same time, grafted over a dwell time of a total of 2.5 min. While the inside temperature of the grinding system was 25° C. at the beginning of the grinding process, it increased to 120° C. during the grinding process.

The graft-maleinated EPDM was freed of volatile residual monomer and residual initiator by means of nitrogen flushing.

The characteristic values determined are indicated in Table 1.

### EXAMPLES 2 to 30

The grafting parameters can be varied by means of variation of step C), particularly the grinding temperature, the dwell time of the mixture in the grinding system, whereby the degree of grafting is essential (see Tables 1 and 2). For the examples listed in the tables, the grinding and grafting temperature was selected in the range from 60 to 120° C., while the dwell time was kept constant at 2.5 min.

While the other three method steps—shredding A), mixing B), and nitrogen flushing D)—are carried out in accordance with the information given above, the grinding/grafting C) of elastomers (Table 1: Examples 1 to 14) and olefin thermoplastics (Table 2: Examples 15 to 30) were varied, with the information being provided in both tables.

The following were used as starting components:

Elastomers: Aside from EPDM as indicated above, crosslinked natural rubber (NR) and butyl rubber (IIR)

Olefin thermoplastics: Homopolypropylene (PP), polyethylene (HDPE), and a branched polyethylene (LDPE)

Monomers: Maleic acid anhydride (MSA) and acrylic acid (AS)

Peroxides: Dibenzoyl peroxide (BPO) and dicumyl peroxide (DCP)

TABLE 1
Grinding and grafting of recycled rubber

| | Elastomer | Particle | Polar | Peroxide | Grinding and | Degree of |
|---|---|---|---|---|---|---|
| | basis | size | monomer | initiator | grafting temp. | grafting |
| Example No. | 100 MT | [mm] | [MT] | [MT] | [° C.] | [mass-%] |
| 1 | EPDM | <0.63 | 5 MSA | 2 BPO | 120 | 1.6 |
| 2 | EPDM | <0.20 | 5 MSA | 2 BPO | 120 | 1.7 |
| 3 | EPDM | <0.63 | 5 AS | 2 BPO | 120 | 1.5 |
| 4 | EPDM | <0.20 | 5 AS | 2 BPO | 120 | 1.6 |
| 5 | EPDM | <0.63 | 5 AS | 2 DCP | 120 | 1.5 |
| 6 | EPDM | <0.20 | 5 AS | 2 DCP | 120 | 1.6 |
| 7 | EPDM | <0.63 | 5 MSA | 2 DCP | 120 | 1.6 |
| 8 | EPDM | <0.63 | 5 MSA | 2 DCP | 120 | 1.7 |
| 9 | EPDM | <0.63 | 5 AS | 2 BPO | 80 | 1.4 |
| 10 | EPDM | <0.63 | 5 AS | 2 DCP | 80 | 1.7 |
| 11 | NR | <0.63 | 5 AS | 2 BPO | 120 | 1.5 |
| 12 | NR | <0.63 | 5 MSA | 2 BPO | 120 | 1.6 |
| 13 | IIR | <0.63 | 5 AS | 2 BPO | 120 | 1.4 |
| 14 | IIR | <0.63 | 5 MSA | 2 BPO | 120 | 1.5 |

TABLE 2
Grinding and grafting of recycled thermoplastics

| | | | | | Grinding and | Degree |
|---|---|---|---|---|---|---|
| | Thermoplastic | Particle | Polar | Peroxide | grafting | of |
| Example | basis | size | monomer | initiator | temp. | grafting |
| No. | 100 MT | [mm] | [MT] | [MT] | [° C.] | [mass-%] |
| 15 | PP | <1 | 5 AS | 2 DCP | 80 | 1.9 |
| 16 | PP | <0.63 | 5 AS | 2 DCP | 80 | 2.0 |
| 17 | PP | <1 | 5 MSA | 2 DCP | 80 | 1.9 |
| 18 | PP | <0.63 | 5 MSA | 2 DCP | 80 | 2.0 |
| 19 | PP | <1 | 5 AS | 2 LPO | 80 | 1.6 |
| 20 | PP | <0.63 | 5 AS | 2 LPO | 80 | 1.7 |
| 21 | PP | <1 | 5 AS | 2 DCP | 80 | 1.7 |
| 22 | PP | <0.63 | 5 AS | 2 DCP | 80 | 1.8 |
| 23 | HDPE | <1 | 5 AS | 2 DCP | 80 | 1.7 |
| 24 | HDPE | <0.63 | 5 AS | 2 DCP | 80 | 1.8 |
| 25 | HDPE | <1 | 5 MSA | 2 DCP | 80 | 1.7 |
| 26 | HDPE | <0.63 | 5 MSA | 2 DCP | 80 | 1.9 |
| 27 | LDPE | <1 | 5 AS | 2 DCP | 80 | 1.5 |
| 28 | LDPE | <0.63 | 5 AS | 2 DCP | 80 | 1.6 |
| 29 | LDPE | <1 | 5 MSA | 2 DCP | 80 | 1.6 |
| 30 | LDPE | <0.63 | 5 MSA | 2 DCP | 80 | 1.7 |

Although only a few embodiments of the present invention have been shown and described, it will become apparent that many changes and modifications may be made thereunto without departing from the spirit and scope of the invention.

What is being claimed is:

1. A method for producing polar-modified rubber or thermoplastic waste for treatment comprising the following steps:
(a) comminuting in a comminution system scrap parts comprising a vulcanized elastomeric material or an olefin thermoplastic material to particle size diameters of approximately 4 and 8 mm;
(b) mixing in a mixing system the elastomeric material or thermoplastic material following comminution with a peroxide initiator comprising at least one organic peroxide and an α,β-ethylene compound having at least one unsaturated polar group to produce a mixture;
(c) simultaneously grinding and grafting in a grinding system the mixture produced in step (b) at dwell times between 30 seconds and 10 minutes within a temperature range between 40° C. and 140° C. to obtain a ground reaction product having a particle size diameter of <1 mm; and
(d) removing via nitrogen flushing residual monomer components, residual initiator components, and volatile reaction product from the ground reaction product.

2. The method according to claim 1, wherein the elastomeric material is seleted from the group consisting of recycled rubber on an elastomer basis of ethylene-propylene-diene terpolymers (EPDM), natural rubber (NR), styrene-butadiene rubber (SBR), butadiene rubber (BR), acryl nitrile-butadiene rubber (NBR), polyisoprene (IR), butyl rubber (IIR), chloroprene rubber (CR), epichlorhydrine copolymer rubber (ECO), ethylene/acrylate copolymer rubber (AEM), acrylate rubber (ACM), and silicone rubber.

3. The method according to claim 1, wherein the thermoplastic material is selected from the group consisting of recycled thermoplastics on the basis of polypropylenes (PP), including propylene homopolymers (HPP), statistical and hetero-phase propylene copolymers (RCP, HCP) and of polyethylenes (PE), including high density polyethylene (HDPE), low density polyethylene(LDPE), and linear low density polyethylene (LLDPE), and ethylene copolymers, including ethylene/vinyl acetate (EVA), ethylene/(meth)acrylate copolymers (EMA).

4. The method according to claim 1, wherein the unsaturated polar group comprises a polar monomer selected from the group consisting of acrylic acid, maleic acid anhydride, acryl amide, vinyl acetate, and vinyl acetate/styrene mixtures.

5. The method according to claim 1, wherein the peroxide initiator is selected from the group consisting of dibenzoyl peroxide, dilauroyl peroxide, and dicumyl peroxide.

6. A compatibility agent for a polymer compound comprising a polar-modified rubber or olefin thermoplastic wasete produced by the process of claim 1.

7. An adhesion agent for a multi-layer composite comprising a polar-modified rubber or olefin thermoplastic waste produced by the process of claim 1.

8. An absorbent comprising a polar-modified rubber or olefin thermoplastic waste produced by the process of claim 1.
